(19) United States
(12) Patent Application Publication
(10) Pub. No.: US 2010/0065327 A1
(43) Pub. Date: Mar. 18, 2010

(54) Cable assembly with molded grounding bar and method of making same

(75) Inventors: Yuan-Chieh Lin, Lake Forest, CA (US); Jim Zhao, Fullerton, CA (US); Tien-Lu Kao, Fullerton, CA (US)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD.

(21) Appl. No.: 12/284,033

(22) Filed: Sep. 17, 2008

(51) Int. Cl. H02G 15/08; H01R 43/00

(52) U.S. Cl. 174/88 C; 29/876

(57) ABSTRACT

A cable assembly (1000) includes a plurality of wires (1), each wire (1) including an inner conductor (10), an insulative layer (12) enclosing the inner conductor, a metallic braiding member (14) shielding the insulative layer, and an jacket (16) enclosing the metallic braiding member; a partial of the jacket of the each wire removed away to expose a partial of the corresponding metallic braiding member outside; and a conductive grounding bar (2) molded over the partial of the corresponding metallic braiding member of the each wire such that the wires and the grounding bar are electrically and mechanically linked together.

### FIELD OF THE INVENTION

The present invention generally relates to a cable assembly, and more particularly to a cable assembly having a molded grounding bar attached thereto.

### DESCRIPTION OF PRIOR ART

Computers and other signal processing devices utilize connectors to communicate signals to locations exterior to the computer. The signals are typically transmitted through a plurality of wires or cables which are connected to the computer through a connector. Shielded wires or shielded cables (hereinafter referred to collectively as “shielded wires”) have a conductive shield braid surrounding signal wire(s) on which the signals are transmitted. The shield braid prevents noise from appearing on the signal wire, controlling interference between adjacent signal wires.

The shield braid of each shielded wire is grounded. Shielded wires have their inner conductors connected directly into the connector, but the shield braid connected to an exterior portion of the connector to ground the shield braid. Typically, the shielded wire has a length of insulation removed to expose the shield braid, and the shield braid is directly attached to the connector (for example, connected to a ring terminal which is attached to the connector through a screw) or connected indirectly to the connector through a grounding block (also called a grounding bar or grounding bus, etc.).

The grounding block includes multiple terminals, each of which is adapted to have a pin which is affixed to the shield wire. Grounding blocks allow connections of the shielded cable to be made easily. For example, U.S. Pat. No. 6,772,516, issued to Lomastro on Aug. 10, 2004 discloses a grounding block which is made of several parts below. A main body includes a plurality of holes formed therein a main clip and includes an exterior contact portion positioned exterior to the main body, a first carrier strip connected to the exterior contact portion and located within the main body and a plurality of clips extending from this carrier strip, each position within a corresponding hole formed in the main body. A slave clip includes a carrier strip located within the main body and a plurality of clips extending from the carrier strip, each positioned within a corresponding hole of the main body to make the corresponding one of the clips of the main clip. The pair of the clips formed within each hole form a terminal to allow terminal portions of a grounding wire to be connected therein. A cap has a plurality of holes corresponding in position and size to the holes formed in the main body may be frictionally engaged in a hollow portion of the main body to complete the assembly.

However, prior art grounding block is complicated to manufacture, thus increasing it cost to manufacture.

Therefore, a simple and easy manufactured grounding bar (or grounding block) for a cable assembly is required to overcome aforementioned problems.

### SUMMARY OF THE INVENTION

Accordingly, an object of the present invention is to provide a cable assembly with a molded grounding bar.

In order to achieve the object set forth, a cable assembly in accordance with the present invention comprises a plurality of wires, each wire including an inner conductor, an insulative layer enclosing the inner conductor, a metallic braiding member shielding the insulative layer, and an insulative jacket enclosing the metallic braiding member; a partial of the jacket of a front portion of the each wire removed away to form a cavity therein to expose a partial of the corresponding metallic braiding member outside, and a remaining insulative jacket of the front portion of the each wire still enclosing the metallic braiding member of the front portion of the each wire; and a conductive grounding bar molded over the partial of the corresponding metallic braiding member inside the cavity of the each wire.

Other objects, advantages and novel features of the invention will become more apparent from the following detailed description when taken in conjunction with the accompanying drawings.

### BRIEF DESCRIPTION OF THE DRAWINGS

FIG. 1 is an assembled, perspective view of a cable assembly;

FIG. 2 is a partially exploded, perspective view of a cable connector assembly;

FIG. 3 is a bottom plan view of the cable assembly; and

FIG. 4 is a right side elevational view of the cable assembly.

### DETAILED DESCRIPTION OF PREFERRED EMBODIMENTS

Reference will now be made in detail to the preferred embodiment of the present invention.

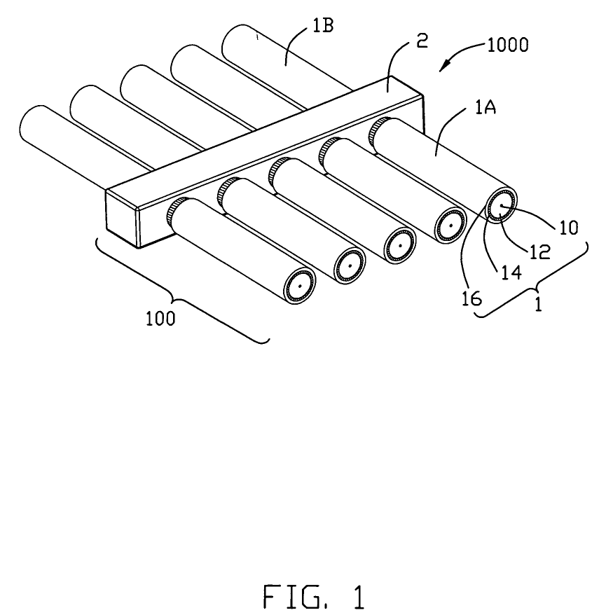

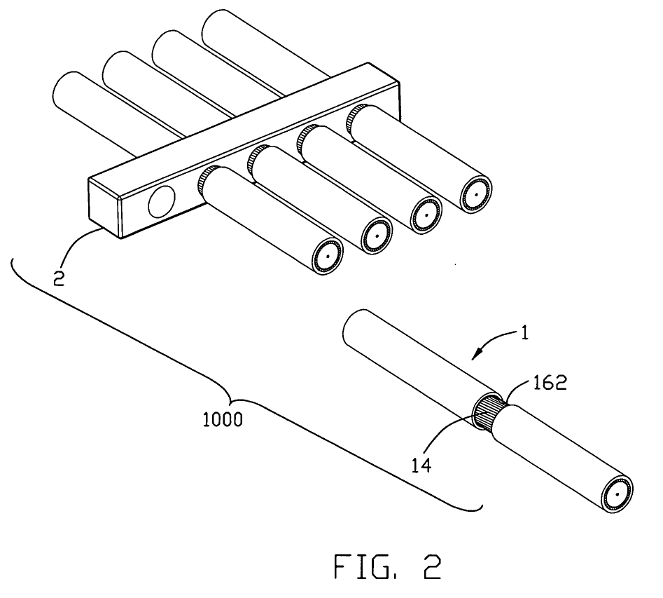

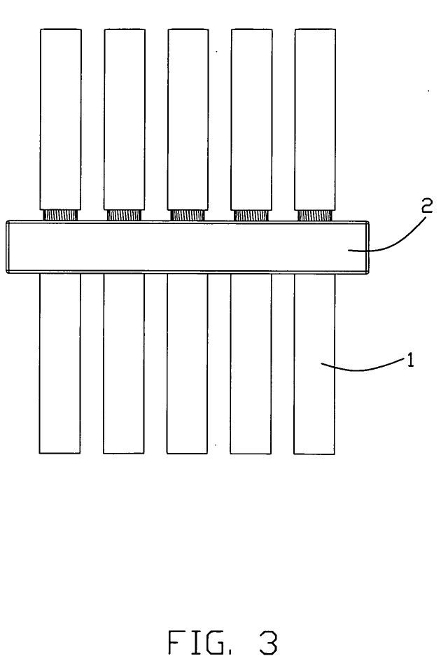

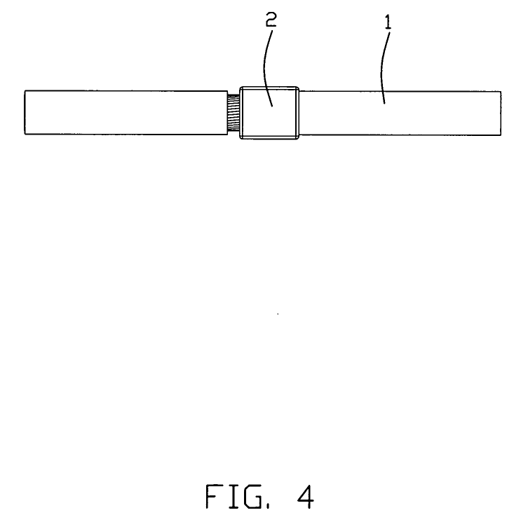

Referring to FIGS. 1-4, a cable assembly 1000 comprises a plurality of wires 1 and a grounding bar 2 permanently integrated with the wires 1 by an injection molding process. The wires 1 may be micro coaxial wires, ultra micro coaxial wires, and the like. The grounding bar 2 is a solid body after molding process, and it may be conductive plastic or other conductive material. One kind of preferred conductive material includes 15% thermoplastic, 55% copper fiber and 30% low melting alloy.

Each of the wires 1 comprises an inner conductor 10, an insulative layer 12 shielding the inner conductor 10, a metallic braiding member 14 enclosing an outside of the insulative layer 12 and insulated from the inner conductor 10, and an insulative jacket 16 enclosing a peripheral portion of the metallic braiding member 14. The insulative jacket 16 is made of plastic material or other insulative materials.

Each of the wires 1 has a certain distance and extends along an axial direction thereof or a front-to-back direction. The wire 1 includes two segments along the axial direction, a termination segment (or front segment) 1A for connecting to a connector (not shown) and an intermediate segment (or rear segment) 1B adapted for connecting to an electronic component (not shown) or another connector (not shown). Both the termination segment 1A and the intermediate segment 1B have a certain lengths along the axial direction, and covered by the insulative jacket 16. And the intermediate segment 1B is longer than the termination segment 1A.

A partial of the insulative jacket 16 of the front portion of the intermediate segment 1B (or the rear portion of the termination segment 1A) of the wire 1 is removed to form a loop-shaped groove 162 therein and to have a partial of the corresponding metallic braiding member 14 along its axial direction exposed outside, and the whole insulative jacket 16 of termination portion 1A or remaining insulative jacket 16 of the termination portion 1A is still attached to the corresponding metallic braiding member 14. However, the groove may be a cavity which is formed after a partial of jacket 16 is stripped away. The remaining insulative jacket 16 of the termination portion 1A may bound the metallic braiding member 14 therein, as the metallic braiding member 14 is made of a great deal of fine conductive wires and they are fragile and spread if no such precaution, which may bring some problem when the wire 1 is soldered to the connector. Anyhow, a certain length of insulative jacket 16 attached to the front part of the termination portion 1A is necessary, and such arrangement would bring much convenience in manufacturing the cable assembly.

The grounding bar 2 is molded over the partial of the corresponding metallic braiding member 14 inside of the loop-shaped groove 162 of the each wire 1. Therefore, the wires 1 and the grounding bar 2 are electrically and mechanically interconnected/linked together. The wires 1 are located at a same plane and a distance between each of two adjacent ones is same.

The grounding bar 2 and the termination portion 1A of the wires 1 may be regarded as connection portions 100 for being coupled to a connector (not shown). In one of exemplary application (not shown), which is quite similar to U.S. Pat. No. 7,311,552, issued to Ko on Dec. 25, 2007 (hereinafter US'552 patent). In US'552 patent, a back side 520 of a metal shell 52 may be read as a grounding bar. The back side 520 defines a plurality of cavities 522 for receiving and contacting metal braiding members 42 of wires 4. Furthermore, an elongated spacer 3 defines a plurality of grooves 323 for positioning the wires 4 to make it easy to solder the wires 4 to contacts 2 supported by insulated housing 1. Compared to US'552 patent, the grounding bar 2 of the present invention not only serves as grounding means, but also has a function of aligning or positioning wires. Furthermore, the grounding bar 2 of the present invention may be molded over any other part of the wire 1 to form a grounding path, not like those in prior arts, the grounding bar or grounding block must assembled to an insulated housing. The grounding bar 2 can also be enclosed within metal shell of a corresponding connector (not shown) and soldered thereto. The grounding bar 2 may be molded over any place of the wires 1 and attached to a cage (not shown) of an electronic device (not shown), too.

A method for making the cable assembly comprises several steps below: providing a number of wires 1, each of the wires 1 including an inner conductor 10 enclosed within and insulated from a metallic braiding member 14 and an insualtive jacket 16 shielding the metallic braiding member 14; removing a partial of the insulative jacket 16 of a front segment of the each wire to expose the metallic braiding member 14 and preserving a rest of (a certain length of) the insulative jacket 16 in front of the exposed metallic braiding member 14; arranging the wires 1 in a row and having the exposed metallic braiding members 14 of the wires 1 aligning with one another along a transversal direction; having melted conductive material molded over the metallic braiding members 14 exposed outside to form a grounding bar 2. The wires 1 are disposed at a same plane and spaced from one another, and a distance between every two adjacent wires 1 is identical.

It will be understood that the invention may be embodied in other specific forms without departing from the spirit or central characteristics thereof. The present examples and embodiments, therefore, are to be considered in all respects as illustrative and not restrictive, and the invention is not to be limited to the details given herein.

1. A cable assembly, comprising:
a plurality of wires, each wire including an inner conductor, an insulative layer enclosing the inner conductor, a metallic braiding member shielding the insulative layer, and an insulative jacket enclosing the metallic braiding member;
a partial of the jacket of a front portion of the each wire removed away to form a cavity therein to expose a partial of the corresponding metallic braiding member outside, and a remaining insulative jacket of the front portion of the each wire still enclosing the metallic braiding member of the front portion of the each wire; and
a conductive grounding bar molded over the partial of the corresponding metallic braiding member inside the cavity and further over a portion of the insulative jacket disposed behind and adjacent to the groove of the each wire.

2. The cable assembly as recited in claim 1, wherein the grounding bar is permanently integrated with the wires.

3. The cable assembly as recited in claim 1, wherein the cavity encircles around the corresponding metallic braiding member.

4. The cable assembly as recited in claim 3, wherein the grounding bar is molded over entire peripheral of the corresponding metallic braiding member.

5. The cable assembly as recited in claim 1, wherein the wires are arranged in at least a row along a transversal direction.

6. The cable assembly as recited in claim 5, wherein a distance between the two adjacent wires is identical.

7. The cable assembly as recited in claim 1, wherein the grounding bar is made of thermoplastic, copper fiber and low melting alloy.

8. The cable assembly as recited in claim 1, wherein the grounding bar includes 15 percent thermoplastic, 55 percent copper fiber and 30 percent low melting alloy.

9. A method of making a cable assembly, the method comprising steps of:
providing a number of wires, each wire including an inner conductor, a metallic braiding member shielding and insulated from the each wire, and an insulative jacket shielding the metallic braiding;
removing a certain length of the insulated jacket of a front portion of the each wire to expose a partial of the corresponding metallic braiding member outside, and having a rest of insulative jacket of the front portion still enclosing the metallic braiding member;
arranging the wires in a row and having the corresponding metallic braiding members disposed adjacent one another; and
molding a conductive material over the corresponding metallic braiding members and further over portions of the insulative jackets disposed behind and adjacent to the corresponding metallic braiding members to form a grounding bar.

10. The method of making the cable assembly as recited in claim 9, wherein the wires are arranged in juxtaposed manner and have same distance between the adjacent ones.

11. The method of making the cable assembly as recited in claim 9, wherein the length of the jacket is stripped away from the metallic braiding member to from a loop groove.

12. The method of making the cable assembly as recited in claim 11, wherein the conductive material is applied to the loop groove by injection molding process to form the grounding bar to electrically and mechanically connect the wires together.

13. A cable assembly comprising:
a plurality of wires each including an inner conductor, an inner insulator, an outer conductor and an outer insulator enclosing one another in sequence;
the outer insulators of said wires being removed at positions of said wires arranged in line along a transverse direction to expose the outer conductors to an exterior; and
a conductive grounding bar with through holes therein to have said wires extend therethrough with the outer conductors at said positions located in said through holes, respectively, with an electrical and mechanical connection therebetween; wherein
each of said wires is equipped with the outer insulator by substantially two sides of said grounding bar for keeping a stable electrical character therealong wherein said grounding bar is of one piece molded over the wires in an intimate manner, and said originally exposed outer conductor defines two opposite ends axially under condition that one end of the exposed outer conductor is located axially outside of the grounding bar and radially exposed to an exterior, while the other end of the exposed outer conductor is radially hidden under the grounding bar.

14. The cable assembly as claimed in claim 13, wherein said grounding bar further axially extends over said other end to cover the outer insulator.
